(19) United States
(12) Patent Application Publication
(10) Pub. No.: US 2013/0286636 A1
(43) Pub. Date: Oct. 31, 2013

(54) LIGHT STRAND WITH INTEGRATED ORNAMENTS

(71) Applicant: ESTEE MARTIN, Orlando, FL (US)

(72) Inventor: ESTEE MARTIN, Orlando, FL (US)

(21) Appl. No.: 13/459,922

(22) Filed: Apr. 30, 2012

(51) Int. Cl. F21S 6/00

(52) U.S. Cl. 362/123

(57) ABSTRACT

A light strand with integrated ornaments includes an elongated power cord positioned within a protective sheath having an electric plug at a first end and an electric receptacle at a second end. A plurality of lighted elements and decorative ornaments are secured along the length of the cord, and at least one of the decorative ornaments being suspended from the cord via a tether. A light strand with integrated ornaments also includes a plurality of connectors and lighted connectors for removably securing the ornaments to the sheath.

### TECHNICAL FIELD

The present invention relates generally to decorative illumination, and more particularly to a light strand with integrated ornaments adapted for mounting as a single unit on a Christmas tree or the like.

### BACKGROUND

The statements in this section merely provide background information related to the present disclosure and may not constitute prior art.

Each year, people across the globe participate in the time honored tradition of decorating a Christmas tree. Sometimes, trees are decorated by families as a way to celebrate the holidays together. Other times, Christmas trees are decorated by merchants for display to holiday shoppers. In either situation, the most common elements utilized during the decoration procedure involves strands of lights and multiple ornaments.

Conventional Christmas tree lighting sets commonly include a plurality of female socket elements, each adapted to receive a screw-in or bayonet-type lamp element, mounted in a spaced relationship along an electric cord having a power plug at one end and a socket for attaching to other light strings at the second end. Such sets conventionally have the lamp elements arranged in either a series or parallel connection and the voltage and current ratings of the lamp elements employed are selected in accord therewith. More recently, lighting sets have begun to incorporate energy saving LED elements which provide greater illumination and utilize less energy. One conventional lighting set example includes U.S. Pat. No. 4,223,248 to Tong, the contents of which are incorporated herein by reference.

After selecting a Christmas tree for decoration, a user will typically drape the light strand onto the tree in a circular motion wherein the strand rests upon the tree branches as the user circles the tree. Once the lights are secured to the tree, the user will then hang a plurality of conventional ornaments which are configured to hang from the tree branches via a thin metal or plastic hook.

Unfortunately, during the decorating procedure and afterwards, many of the ornaments become dislodged from the tree, either from inadvertent contact by an individual, or by the hook slipping from the branch. When the ornaments fall, they often become broken and/or separated from their hanging hook, which makes finding and re-hanging the ornaments in the desired location difficult.

In addition to the above problems, it is noted that the decorating procedure often takes a great deal of time, as each of the elements must be individually mounted onto the tree. While this may not be a problem for families, the time for merchants could be better spent on more profitable tasks.

Accordingly, there is a need in the art for a light strand with integrated ornaments capable of quickly and easily providing an aesthetically pleasing arrangement of lights and ornaments onto a Christmas tree or other such object that does not suffer from the drawbacks described above.

### SUMMARY OF THE INVENTION

The present invention is directed to light strand device with integrated ornaments. One embodiment of the present invention can include an elongated power cord positioned within a protective sheath having an electric plug at a first end and an electric receptacle at a second end. A plurality of lighted elements and decorative ornaments are secured along the length of the cord, and at least one of the decorative ornaments are suspended from the cord via a tether in order to provide a three dimensional appearance.

Another embodiment of the present invention can include a series of connectors interposed between the decorative ornaments and sheath in order to allow each of the ornaments to be removably secured to the sheath.

Yet another embodiment of the present invention can include a series of lighted connectors interposed between the decorative ornaments and sheath in order to allow each of the ornaments to be illuminated when secured to the sheath.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a frontal view of a light strand with integrated ornaments in accordance with one embodiment of the invention.

FIG. 2a is a frontal view of a light strand with integrated ornaments in accordance with another embodiment of the invention.

FIG. 2b is a perspective view of the light strand with decorative ornaments in operation, in accordance with one embodiment of the invention.

FIG. 3 is a frontal view of a light strand with integrated ornaments in accordance with an alternate embodiment of the invention.

FIG. 4 is a frontal view of a light strand with integrated ornaments in accordance with another alternate embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

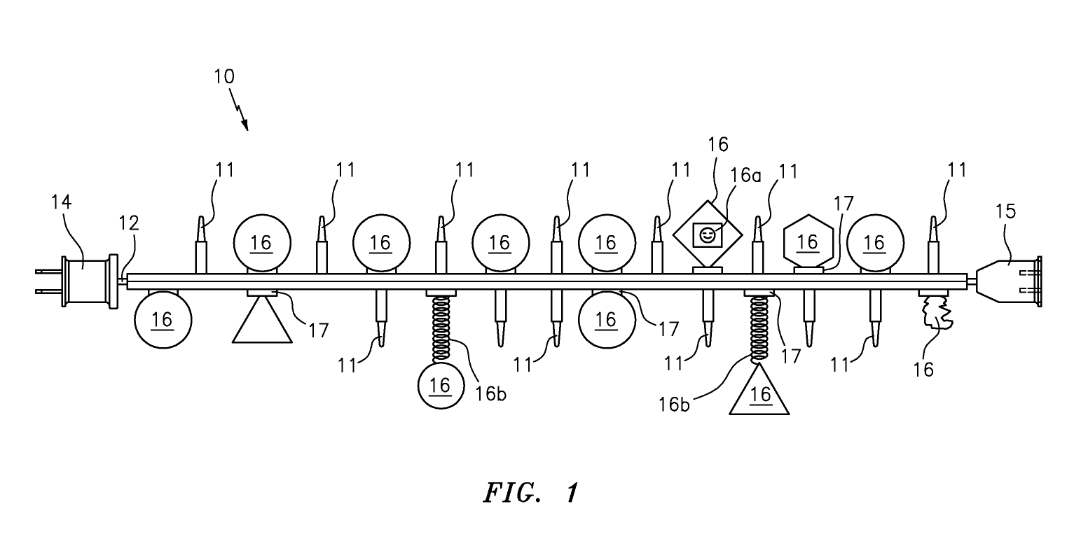

For purposes of this description, the terms “upper,” “bottom,” “right,” “left,” “front,” “vertical,” “horizontal,” and derivatives thereof shall relate to the invention as oriented in FIG. 1. FIGS. 1-4 illustrate various embodiments of a light strand with integrated ornaments 10 that are useful for understanding the inventive concepts disclosed herein.

FIG. 1 illustrates one embodiment of the light strand with integrated ornaments 10 that includes a plurality of lighted elements 11 connected together via an electrical cable/power cord 12 positioned within a protective sheath 13. A conventional plug 14 and socket 15 are located at opposite ends of the sheath, and a plurality of ornaments 16 are interposed thereon.

Each of the lighted elements 11 can act to provide illumination to a decorated object in a conventional manner. As described herein, each of the lighted elements 11 can include any size, shape or type of conventional bulb such as LEDs or incandescent lighting, for example, and the associated harness. The plug 14 acts to receive electrical power from an outside source and transfer the same to the lighted elements 11 and the socket 15 in a conventional manner. The flexible sheath acts to protect against electric shock in a conventional manner and will preferably include a color (such as green, for example) to help to blend in to the decorated object. Each of the lighting elements 11 can be connected in series or parallel to one another, in accordance with known construction methodologies.

In one preferred embodiment, multiple ornaments 16 can be permanently affixed to the sheath 13 via a strong adhesive 17 such as glue, for example, in order to form a single integrated device. Of course, other materials capable of bonding the ornament and sheath together including rubber cement and other conventional bonding agents are also contemplated.

As described herein, each of the plurality of ornaments can comprise decorative elements having any number of different shapes, sizes, colors, markings, and/or optional features such as picture holders 16a and the like. Additionally, one or more of the ornaments can be connected to the sheath via a tether 16b, in order to suspend the ornament from the sheath in any direction. Such a feature can provide a three dimensional appearance to the device when positioned onto a decorated object, such as a Christmas tree, for example, and can act to broaden the decorative area that the device can cover.

As described herein, the tether 16b can preferably include an elongated strand of monofilament wire so as to be invisible when placed onto the decorated object. However, other conventional items like green string and/or permanently affixed (soldered) wire can also be utilized herein. Additionally, the picture holder 16a can comprise an opening into which a portrait or photograph can be placed in order to be viewed by a user.

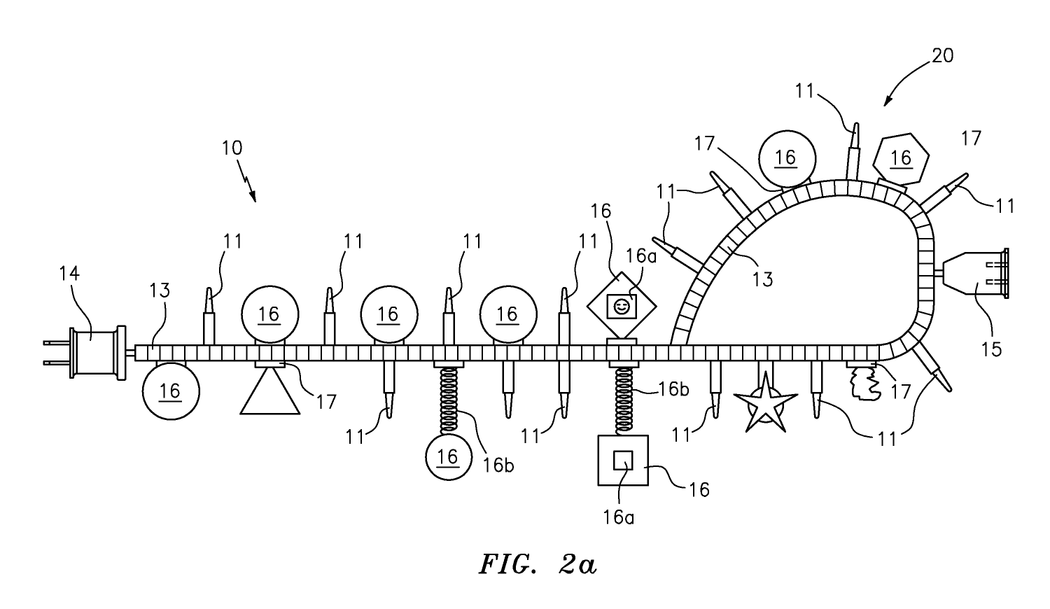

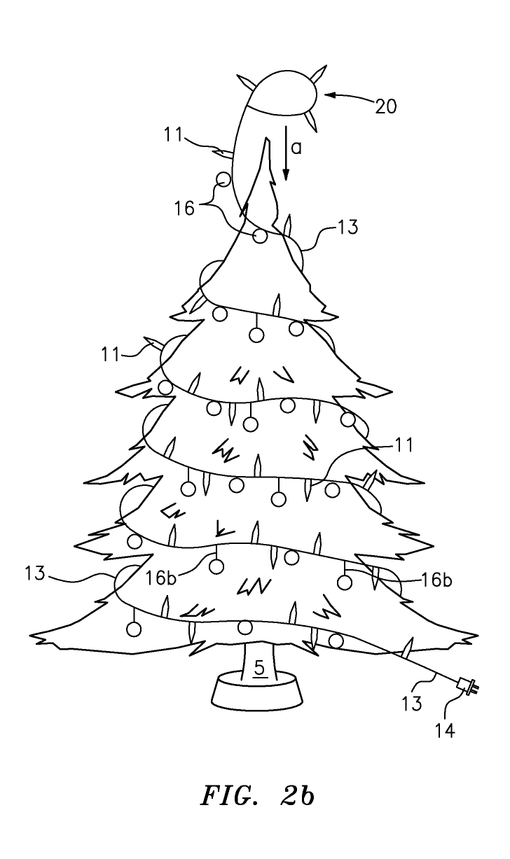

FIG. 2a illustrates another embodiment of the device 10 wherein the cable 12 and sheath 13 form a looped portion 20 at one end for suspending the device from the apex of a Christmas tree or other decorated object. As shown, the looped portion can also include lighted elements 11 and ornaments 16 for providing decorations around the entirety of the upper branch. The loop 20 can be formed utilizing conventional construction techniques suitable for allowing the loop to support the weight of the entire device.

FIG. 2b illustrates one embodiment of the light strand with integrated ornaments 10 in operation on a Christmas tree. As shown, the loop portion 20 can be placed around the uppermost branch of the tree 5 (see arrow a), and the remainder of the device can be suspended and/or wound around the tree until reaching the bottom where the plug can be inserted into a power source. By including the loop portion 20, the present invention advantageously allows a user to precisely and securely position the device onto a tree without fear of the device becoming dislodged or falling off. Although dimensions are not critical, in one embodiment the device can include a length of between 15 and 25 feet, for example, sufficient to decorate an entire tree without requiring additional lighting strands or ornaments.

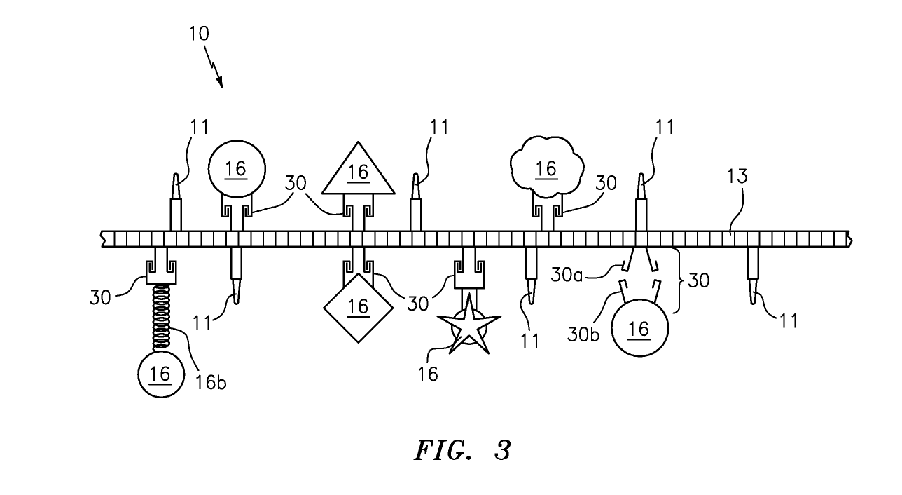

FIG. 3 illustrates an alternate embodiment of the light strand with integrated ornaments 10 that further includes a plurality of interchangeable connectors 30 interposed between the ornaments 16 and the sheath 13. Connectors 30 can allow each ornament to be removably secured to the sheath based on the particular preferences of a user. To this end, the connector 30 allows the device to be customized with new ornaments over time without having to replace the entire device. Such a feature can help to prevent waste, and encourage environmentally friendly practices.

In one preferred embodiment, each connector 30 can include opposing (e.g., male and female) segments/clips 30a and 30b that are permanently secured to the sheath 13 and ornaments 16, respectively. Each of the segments can therefore include complementary shapes for allowing a user to selectively engage and disengage the ornament 16 from the sheath 13 in a quick and easy manner. Although described above as including a specific shape, this is for illustrative purposes only, as any number of known devices capable of securely affixing two objects together in a removable manner can also be utilized herein. Several non-limiting possibilities include opposing strips of hook and loop material (i.e. Velcro®), magnetic elements, and/or compression fittings such as snaps or thread and socket connectors, for example. Additionally, one or more of the connectors 30 can also include a tether 16b for hanging removable ornaments from the sheath.

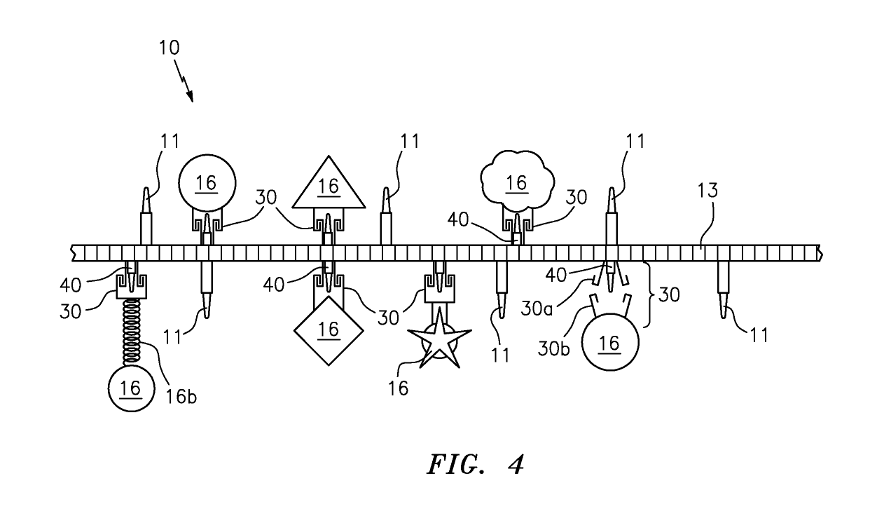

FIG. 4 illustrates another alternate embodiment of the light strand with integrated ornaments 10 that further includes a plurality of lighted connectors 40. As described herein, lighted connectors 40 can include essentially the same components as connectors 30 described above (e.g., male and female segments), and will further include a lighted element 11 secured within, or protruding from the connector segment 40a. Additionally, one or more ornaments 16 can further include an open/transparent top section 16c located adjacent to the ornament connector 40b. Such a feature can allow the light emanating from the lighting element 11 to enter the ornament itself, thus providing additional visual stimulation to a user.

As described herein, one or more elements of the light strand with integrated ornaments 10 can be secured together utilizing any number of known attachment means such as, glue, adhesive bonding, and compression fittings, among others. Moreover, although the above embodiments have been described as including separate individual elements, the inventive concepts disclosed herein are not so limiting. To this end, one of skill in the art will recognize that one or more individual elements such as the ornaments 16 and the connector segments 30b or 40b; ornaments 16 and tethers 16b; and/or ornaments 16, tethers 16b and connectors 30b, for example, may be formed together as one continuous element, either through manufacturing processes, such as welding, casting, or molding, or through the use of a singular piece of material milled or machined with the aforementioned components forming identifiable sections thereof.

Accordingly, the inventive features of the device 10 can allow a user to quickly and easily decorate a tree with both lights and ornaments in a single step, and with a single device, thus saving time and energy. Moreover, by permanently securing the ornaments 16 onto the sheath 13, the device removes the possibility of the ornaments falling from the tree and breaking.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A light strand device with integrated ornaments, comprising:
an elongated power cord positioned within a protective sheath, said cord having an electric plug at a first end and an electric receptacle at a second end;
a plurality of lighted elements disposed along the cord and radiating outward from the sheath;
a plurality of decorative ornaments permanently secured to the sheath; and
at least one tether interposed between one of the plurality of ornaments and the sheath, each of said tethers being configured to suspend a connected ornament from the sheath to provide a three dimensional appearance.

2. The device of claim 1, wherein said tether is constructed from an elongated strand of monofilament wire.

3. The device of claim 1, wherein the power cord and sheath are constructed to form a loop at one end thereof, said loop being configured to support an entire weight of the device.

4. The device of claim 3, wherein the plurality of lighted elements and decorative ornaments are disposed along the entirety of the loop.

5. The device of claim 1, wherein at least one of the decorative ornaments includes a picture holder.

6. The device of claim 1, wherein each of said ornaments includes at least one of a shape, color, marking and size that is different from each of the other ornaments.

7. The device of claim 1, wherein each of said lighted elements include a LED bulb.

8. The device of claim 1, wherein each of said lighted elements include an incandescent bulb.

9. The device of claim 1, wherein said lighted elements are interconnected in a serial configuration.

10. The device of claim 1, wherein said lighted elements are interconnected in a parallel configuration.

11. A light strand device with integrated ornaments, comprising:
an elongated power cord positioned within a protective sheath, said cord having an electric plug at a first end and an electric receptacle at a second end;
a plurality of lighted elements disposed along the cord and radiating outward from the sheath;
a plurality of decorative ornaments; and
a plurality of connectors configured to removably secure each of the decorative ornaments to the sheath,
each of said connectors including a first segment permanently secured to the sheath, and a second segment that is permanently secured to one of the plurality of ornaments.

12. The device of claim 11, wherein each of the connectors includes a compression fitting.

13. The device of claim 11, wherein each of the connectors include at least one of magnetic elements, and strips of hook and loop material.

14. The device of claim 11, wherein at least one of the connectors further includes a tether configured to suspend a decorative ornament from the sheath to provide a three dimensional appearance.

15. The device of claim 11, wherein the power cord and sheath are constructed to form a loop at one end thereof, said loop being configured to support an entire weight of the device.

16. A light strand device with integrated ornaments, comprising:
an elongated power cord positioned within a protective sheath, said cord having an electric plug at a first end and an electric receptacle at a second end;
a plurality of lighted elements disposed along the cord and radiating outward from the sheath;
a plurality of decorative ornaments, each having a transparent top section; and
a plurality of lighted connectors configured to illuminate and removably secure each of the decorative ornaments to the sheath,
each of said lighted connectors including a first segment having a lighted element therein that is permanently secured to the sheath, and a second segment that is permanently secured to one the plurality of ornaments adjacent to the transparent section.

17. The device of claim 16, further comprising:
a plurality of decorative ornaments that are permanently secured directly to the sheath.

18. The device of claim 16, further comprising:
at least one decorative ornament permanently secured to the sheath via an elongated tether, said tether being constructed from a monofilament string.
